(19) United States
(12) Patent Application Publication
(10) Pub. No.: US 2022/0301444 A1
(43) Pub. Date: Sep. 22, 2022

(54) GENERATION OF A FLIGHT PLAN FOR AN UNMANNED AERIAL VEHICLE

(71) Applicant: TELIA COMPANY AB, Solna (SE)

(72) Inventors: Tero JALKANEN, Tuusula (FI); Tomi SARAJISTO, Helsinki (FI)

(21) Appl. No.: 17/642,281

(22) PCT Filed: Sep. 9, 2020
(86) PCT No.: PCT/EP2020/075179

§ 371 Date: Mar. 11, 2022

(30) Foreign Application Priority Data
Sep. 11, 2019 (FI) 20195752

(51) Int. Cl. G08G 5/00; H04W 4/40; H04W 16/22; G01C 21/20

(52) U.S. Cl. CPC G08G 5/0034; H04W 4/40; G08G 5/0013; H04W 16/22; G08G 5/0069; G01C 21/20

(57) ABSTRACT

Disclosed is a method for generating data for a flight plan for an unmanned aerial vehicle. The method includes: receiving data relating to a flight route and data representing at least one service requirement; inquiring a capability to provide the at least one service requirement; receiving a response to the inquiry; and generating data for generating the flight plan in accordance with data included in the response to the control device of the unmanned aerial vehicle. Also disclosed are a network node, a computer program product and a system.

### TECHNICAL FIELD

The invention concerns in general the technical field of unmanned aerial vehicle (UAV). More particularly, the invention concerns a control of UAV.

### BACKGROUND

Recently so-called unmanned aerial vehicles (UAV) have gain popularity as a hobby equipment as well as an equipment used for business purposes. At the same time power and features in the unmanned aerial vehicles have tremendously increased.

The unmanned aerial systems typically comprise the unmanned aerial vehicle itself as well as a control device by means of which a user may control the UAV. The UAV is referred with 110 and the control device with 120 in FIG. 1 illustrating an example of a prior art solution of UAV systems. Here, the UAV corresponds so-called drone. The control device 120 and the UAV 110 are communicatively coupled to each other in order to transfer data between the entities. The data may relate to controlling of the UAV 110 but may also relate to a task the UAV is instructed to perform with its devices, such as transfer of images or video data captured with a camera mounted in the UAV 110. In addition to the mentioned entities the unmanned aerial system may comprise, or utilize, other devices and system, such as a computer device 130. The computer device 130 may be arranged to run a computer program code by means of which it is possible to generate flight plans for the UAV. In order to generate the flight plan the computer program code run in the computer device 130 may retrieve additional data, such as weather forecast, information of restricted flight zones, and so on, from a data network 140, such as from Internet. In other words, the additional data may be used either automatically or manually in the generation of the flight plan. The computer device 130 and the control device 120 and/or even the UAV 110 are communicatively coupled to each other.

However, due to application areas of the unmanned aerial systems there is need to introduce further sophisticated solutions to guarantee operational capability of the unmanned aerial systems.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

At least one object of the invention is to present a method, a network node, a computer program product and a system for generating data for a flight plan for an unmanned aerial vehicle.

The objects of the invention are reached by a method, a network node, a computer program product and a system as defined by the respective independent claims.

According to a first aspect, a method for generating data for a flight plan for an unmanned aerial vehicle is provided, the unmanned aerial vehicle being controllable with a control device, the method comprises: receiving, by a network node, data relating to a flight route of the unmanned aerial vehicle and data representing at least one service requirement for a mobile communication network required by the unmanned aerial vehicle during a flight; inquiring, by the network node, from at least one a mobile communication network a capability to provide the at least one service requirement; receiving, by the network node, from the at least one mobile communication network a response to the inquiry; and generating, by the network node, data for the flight plan in accordance with data included in the response to the control device of the unmanned aerial vehicle.

The response from the at least one mobile communication network may comprise position data representing at least one area where the at least one mobile communication network is capable of fulfilling the at least one service requirement. The data for the flight plan may e.g. be generated in accordance the position data representing the at least one area where the at least one mobile communication network is capable of fulfilling the at least one service requirement.

The at least one service requirement may be at least one of: a bandwidth of a communication channel applicable by the unmanned aerial vehicle; a latency in a communication channel applicable by the unmanned aerial vehicle.

Furthermore, a generation of data for the flight plan may correspond to one of: a generation of at least one flight route; a generation of at least one route point for generating the flight route.

The method may further comprise: inquiring, by the network node, further data for generating data for the flight plan. The further data may be inquired from at least one of: the mobile communication network; a data network. For example, the further data inquired from the mobile communication network may represent a prediction of a traffic load in the mobile communication network. Moreover, the further data inquired from the data network may represent at least one of: data expressing no-fly zone in an area, data expressing special data of one or more targets in the area; weather data.

According to a second aspect, a network node for generating data for a flight plan for an unmanned aerial vehicle is provided, the network node comprising: at least one processor; and at least one memory including computer program code; wherein the at least one memory and the computer program code configured to, with the at least one processor, cause the network node to: receive data relating to a flight route of the unmanned aerial vehicle and data representing at least one service requirement for a mobile communication network required by the unmanned aerial vehicle during a flight; inquire from at least one a mobile communication network a capability to provide the at least one service requirement; receive from the at least one mobile communication network a response to the inquiry; and generate data for the flight plan in accordance with data included in the response to the control device of the unmanned aerial vehicle.

The network node may be arranged to receive the response from the at least one mobile communication network, the response comprising position data representing at least one area where the at least one mobile communication network is capable of fulfilling the at least one service requirement. For example, the network node may be arranged to generate data for the flight plan in accordance with the position data representing the at least one area where the at least one mobile communication network is capable of fulfilling the at least one service requirement.

The at least one service requirement may e.g. be at least one of: a bandwidth of a communication channel applicable by the unmanned aerial vehicle; a latency in a communication channel applicable by the unmanned aerial vehicle.

The network node may be arranged to generate data for the flight plan by one of: generating at least one flight route; generating at least one route point for generating the flight route.

The network node may further be arranged to: inquire further data for generating data for the flight plan.

Still further, the network node may be arranged to inquire the further data from at least one of: the mobile communication network; a data network. For example, the network node may be arranged to interpret the further data inquired from the mobile communication network to represent a prediction of a traffic load in the mobile communication network. Moreover, the network node may be arranged to interpret the further data inquired from the data network to represent at least one of: data expressing no-fly zone in an area, data expressing special data of one or more targets in the area; weather data.

According to a third aspect, a computer program product for generating data for a flight plan for an unmanned aerial vehicle is provided, which computer program product, when executed by at least one processor, cause a network node to perform the method as described above.

According to a fourth aspect, a system for generating data for a flight plan for an unmanned aerial vehicle, the system comprising: a control device, and a network node as described above, wherein the network node is arranged to: receive data relating to a flight route of the unmanned aerial vehicle from the control device; and include data in a response to the control device for generating the flight plan in accordance with data included in the response to the control device of the unmanned aerial vehicle.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an unmanned aerial vehicle system according to a prior art.

FIG. 2 illustrates schematically a UAV system according to an embodiment of the invention.

FIG. 3 illustrates schematically at least some aspects of a network coverage of a mobile network operator with respect to a flight route of a UAV according to an embodiment of the invention.

FIG. 4 illustrates schematically an example of a method according to an embodiment of the invention.

FIG. 5 illustrates schematically a control device executing an application in relation to an example embodiment of the invention.

FIG. 6 illustrates schematically aspects relating to data utilized by a network node according to an embodiment of the invention.

FIG. 7 illustrates schematically an example of a network node according to an embodiment of the invention.

FIG. 8 illustrates schematically an example of a control device according to an embodiment of the invention.

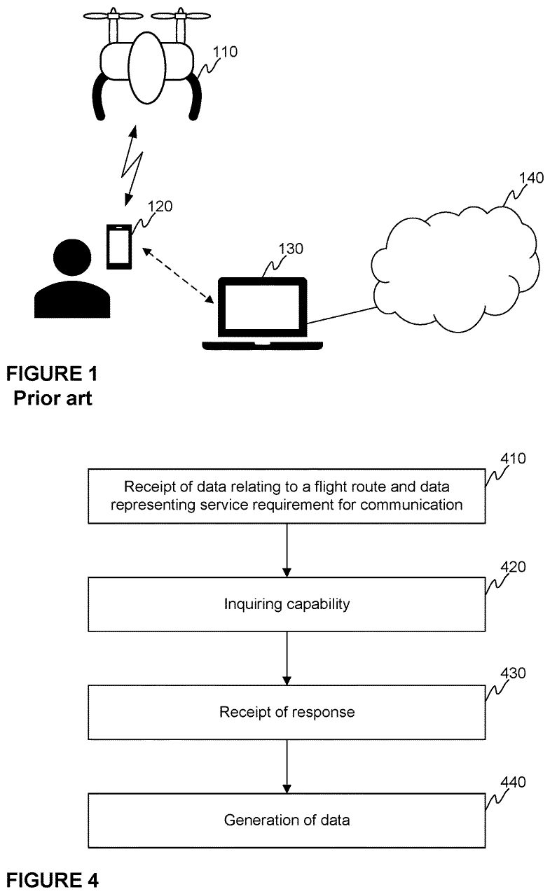

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

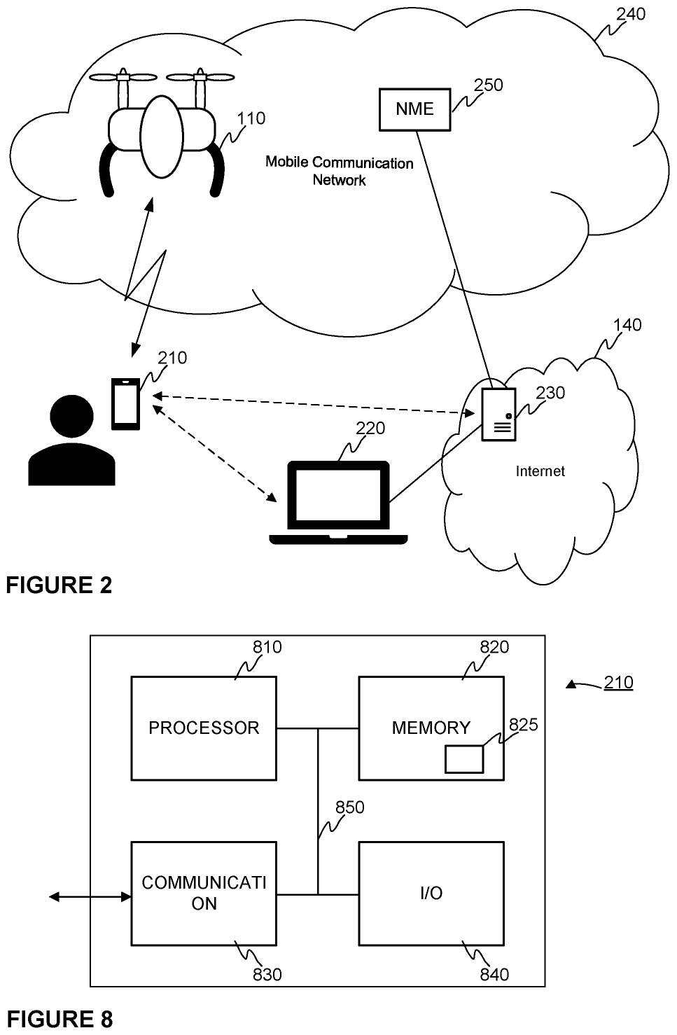

FIG. 2 illustrates schematically a system by means of which a solution according to an example embodiment may be implemented. The system may comprise an unmanned aerial vehicle (UAV) 110, which may correspond to any vehicle available in use. In addition to hardware and software required for enabling the UAV 110 to fly, the UAV 110 may comprise further hardware and software, such as devices and systems, required to perform a specific task. For example, the UAV 110 may be equipped with a camera or any other sensor devices. The UAV 110 may be controlled with a control device 210 according to an example embodiment. A control of the UAV 110 may refer to a generation of signals by means of which the UAV 110 may be caused to operate in a specific manner, such as to flight a specific flight route and/or to use one or more equipment associated with the UAV 110. In addition, the control of the UAV 110 may also comprise a control of a delivery of data from the UAV 110 to the control device 210, or to any other entity. For example, the UAV 110 equipped with a camera may be arranged to deliver a live video stream to the control device 210 or to any other entity, such as to an application server. In addition to the mentioned entities the unmanned aerial system may comprise, or utilize, other devices and system, such as a computer device 220. The computer device 220 may be arranged to run a computer program code by means of which it is possible at least to generate flight plans for the UAV. In order to generate the flight plan the computer program code run in the computer device 220 according to an example embodiment may retrieve additional data by inquiring it from a network node 230 residing in a data network 140, such as in Internet. The network node 230 may be a server device comprising, for example, processing entities, memory entities, communication interfaces and computer program code for communicating with the computer device 220 among other entities as will be described in the forthcoming description. In some example embodiment the generation of the flight plan may be performed with the control device 210 and the communication the network node 230 may be performed directly between the control device 210 and the network node 230.

According to example embodiments the network node 230 may be communicatively coupled to one or more mobile communication network 240 and e.g. to a network management entity 250 therein. The term network management entity shall be understood in a broad manner as a device having access to data indicating one or more service related parameters with respect to a position within a coverage of the mobile communication network 240, or at least a portion of it.

As a non-limiting example an applicable network management entity 250 so-called Mobility Management Entity, MME, may be referred to.

For understanding the example embodiments it is now referred to FIG. 3. FIG. 3 illustrates schematically at least some aspects of a network coverage of a mobile network operator managing a mobile communication network 240. In the non-limiting example of FIG. 3 the network coverage a certain area, such as the area referred with A in FIG. 3. Within the area A a specific service level is available for terminal devices. The specific service level may e.g. be defined by features selected e.g. for base station serving the specific area A and/or with parameters how the network is operated in the area A. Such parameters may e.g. be a bandwidth and a latency as non-limiting examples. In addition to the area A the mobile network operator may have arranged sub-areas within the coverage of the area A wherein the service level differs from a general service level in the area A. The sub-areas may have a service level corresponding to each other, or it may vary between the sub-areas. For the purpose of understanding the example embodiments it is hereby assumed that the sub-areas B, C and D as schematically illustrated in FIG. 3 provide the same service level with respect to each other. The service level of the sub-areas B, C and D may be considered improved compared to the service level of the area A. The improved service level may e.g. refer to an implementation in which one or more network related parameters are set so that the network provides the improved service, such as higher bandwidth and/or shorter latency.

Now, the UAV 110 may be set to perform a certain task requiring the improved service level from the mobile communication network 240. The task may e.g. be a capture of a live video during the flight. The departure point, DP, is referred with 310 in FIG. 3. The destination, D, of the task is referred with 320 in FIG. 3 even though the destination D 310 may correspond to the departure point DP 320. Now, by providing data relating to the flight route, such as the destination D 310, and data representing at least one service requirement, such as task related information, to the network node 230 the network node 230 may be arranged to inquire from at least one mobile communication network operator information on a capability of the mobile communication network to provide the at least one service required for executing the task during the flight. As a result the network node 230 may receive information about the network and based on that to provide one or more flight routes fulfilling the requirements, at least in part. For example, a preferred flight route (referred as 1^{st} route in FIG. 3) may be such which utilizes the sub-areas B, C and D in the network coverage suitable for providing the service level fulfilling the requirements. Additionally, the network node 230 may be arranged to provide alternative routes (referred as 2^{nd} route and 3^{rd} route in FIG. 3) which may or may not fulfill the requirements in a desired manner, such as at least in part.

FIG. 4 illustrates schematically a method according to example embodiment for generating a flight plan for an unmanned aerial vehicle. The method is described from a network node 230 point of view.

Regarding Step 410:

The network node 230 may be arranged to receive data relating to a flight route of an unmanned aerial vehicle, UAV, 110. In addition, the network node 230 may receive data representing at least one service requirement for a mobile communication network required by the UAV 110 during a flight.

More specifically, the data relating to the flight route may be data indicating at least portions of the flight route. At least a destination of the flight may be received, but also a departure point 310 may be required. The destination 320 and the departure point 310 may e.g. be provided manually by the user of an unmanned aerial system e.g. through the control device 210. Alternatively or in addition, at least the departure point may be provided automatically e.g. so that the control device 210 is equipped with a positioning function, such as with a chip suitable for determining a position of the control device 210 on a basis of GPS signals from a global positioning system (GPS). The positioning function may alternatively or in addition be implemented in the UAV 110, which provides data indicating the position to the control device 210, for example. In addition to the mentioned position(s), the data relating to the flight route may comprise further route points e.g. between the departure point 310 and the destination 320. The further route points may also be provided by the user of the unmanned aerial system through the control device 210, for example.

In addition to the provision of the flight route related data the network node 230 may receive data representing service requirement with respect to communication required during a flight. The service requirement may be expressed e.g. as a description of a task the UAV 110 is instructed to perform or as a parameter defining a technical requirement for the communication. The service requirement for the communication may be fulfilled by the mobile communication network the UAV 110 may utilize through a communication device, such as a communication modem, implemented in the UAV 110.

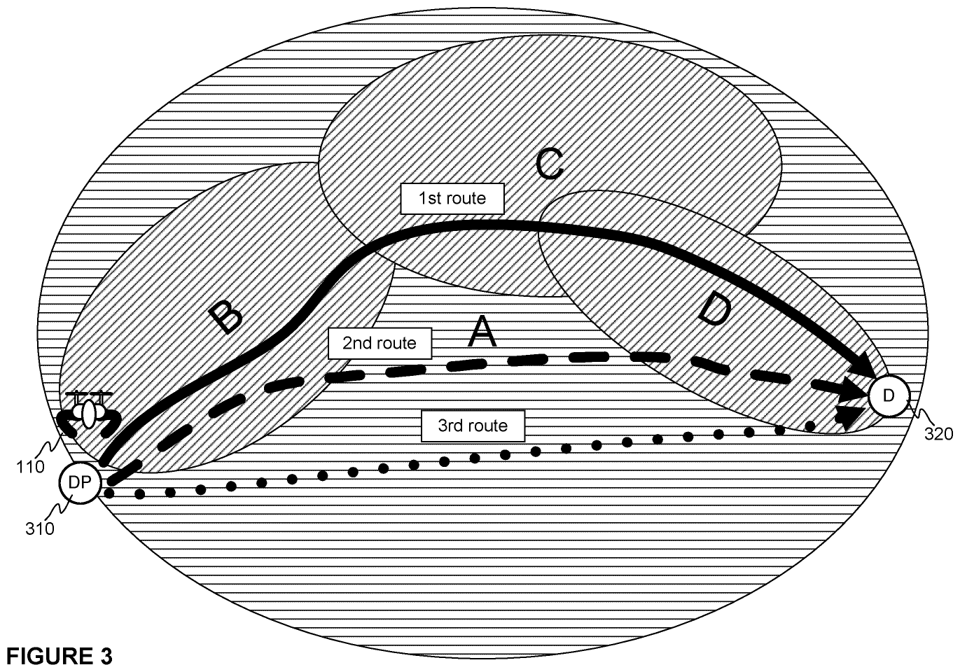

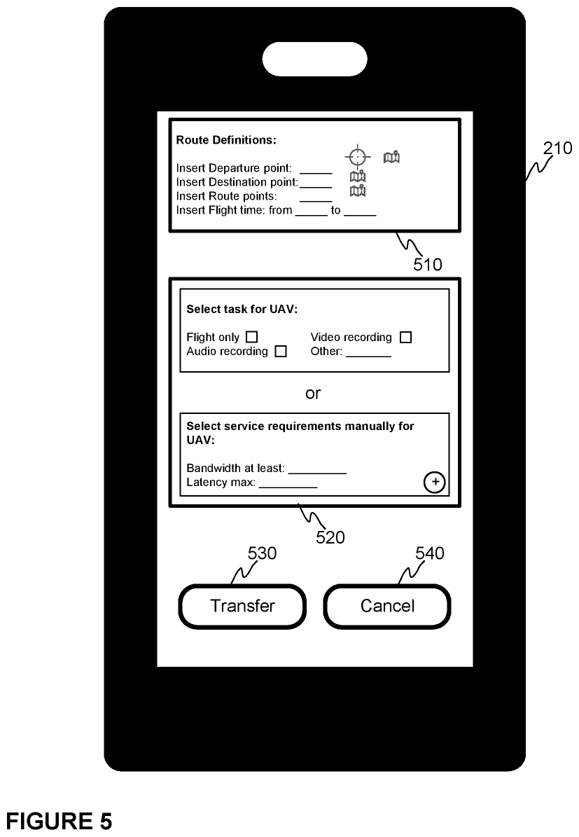

As regards to a provision of the mentioned pieces of data to the network node 230 a specific application may be installed and executed in the control device 210. A user interface may e.g. be as schematically illustrated in FIG. 5. The application may be configured so that it provides a first interactive window 510 for providing flight route related data and a second interactive window 520 for providing data representing at least one service requirement for a mobile communication network. The first interactive window 510 may be configured so that the user of the control device 210 may e.g. insert address information with respect to at least some positions within the route. Alternatively or in addition the first interactive window 510 may comprise icons, such as positioning or map icons. By selecting the icon through an interaction the application may initiate another application, such as to initiate a positioning of the control device 210 by utilizing a positioning system, such as GPS, the control device 210 is capable of utilizing. Alternatively or in addition, the control device 210 may be arranged to initiate a map application by means of which the user may select route points, such as the departure point, the destination point and/or any further route points, from a map operating interactively through the user interface of the control device 210. Additionally, in some example embodiments it may be possible to provide information with respect to a planned time of the flight as schematically illustrated in FIG. 5.

The second interactive window 520 may be implemented so that there are a plurality of sub-windows, such as one sub-window through which the user may provide information with respect to a task the UAV 110 is instructed to perform and another sub-window through which the user may directly input technical parameters defining at least part of the service requirements needed during the flight. According to example embodiment the user may provide data representing at least one service requirement for a mobile communication network required by the unmanned aerial vehicle during a flight through either the first sub-window or the second sub-window or the both. In response to input of the data in the first and the second interactive window the user may transfer 530 the input data to the network node by selecting an interactive button 530. Alternatively, the user may cancel the process by selecting an interactive cancel button 540. In some example embodiment at least the interactive button 530 for transferring the data may be maintained inactive until the user has provided enough input for accessing the transfer phase. This may be achieved by defining fields in which input is obligatory and the application is arranged to monitor it.

Regarding Step 420:

In response to the receipt of the mentioned pieces of data i.e. data relating to the flight route and the data representing at least one service requirement for the mobile communication network required by the UAV the network node 230 may be arranged to inquire capability information 420 from the mobile network operator. The inquiry message may e.g. be delivered to an entity, such as to a network management entity 250, storing network related information. As a non-limiting example an applicable network management entity 250 so-called Mobility Management Entity, MME, may be referred to. As a parameter the inquiry may e.g. comprise one or more position data with respect to route points provided by the user. In response to a receipt of the data the network management entity 250 may generate data comprising coverage information of the mobile communication network with service capability within the area. The generated data may e.g. be a data structure comprising data indicating service capability of the network in the area indicated in the inquiry. According to another example embodiment the network node 230 may be arranged to determine one or more preliminary flight routes in accordance with the data received in step 410 and data, such as route points of the preliminary flight route(s), is delivered to the network management entity 250. Based on the data the network management entity 250 may be arranged to determine and provide network capability data with respect to the preliminary routes to the network node 230 in a response.

The above described mechanisms to inquire capability information of the mobile communication network in accordance with the position data are non-limiting examples and other mechanisms may be applied to.

In addition, the inquiry may carry data representing one or more service requirements for the mobile communication in order to the UAV 110 to perform its task in a desired manner. At least some non-limiting examples of the service requirements are referred in the foregoing description. On the basis of the data representing the service requirements the network management entity 250 may optimize the capability data to be provided in the response in view of the flight route, or any positions of the flight route, provided to the network management entity 250 in the inquiry. Alternatively or in addition, the inquiry may, in various embodiments, comprise further parameters, such as an indication of a time when the flight, such as a departure time of the flight, is planned to occur as well as an indication of a planned flight altitude. The time related parameters may be taken into account in a manner that the mobile communication network 240 may return e.g. statistical history data from which it is possible to determine if at the time of a flight a high number of people exists in a certain location along the flight route and which may affect a service capability of the mobile communication network. This piece of information may e.g. be taken into consideration in a planning of the flight route and/or the task of the UAV 110. Correspondingly, in response to a provision of information on the planned flight altitude in the inquiry the mobile communication network may provide a response indicating a recommended flight altitude e.g. due to a capability to provide a better service than in the planned flight altitude, for example.

Hence, the inquiry is generated in order to receive information with respect to a capability of at least one mobile network operator to provide the at least one service requirement to the UAV 110.

Regarding Step 430:

In step 430 the network node 230 receives the inquired data from the network management entity 250 as a response to the inquiry.

Regarding Step 440:

In response to the receipt of the inquired data the network node 230 may be arranged to generate data for the flight plan. More specifically, the generation of the data for the flight plan may refer to an implementation in which the network node 230 processes the received data e.g. by comparing the data representing the capability of the mobile communication data with at least one service requirement, such as minimum bandwidth and/or maximum latency, necessary for performing the task by the UAV 110. For example, if the data provided by the network management node 250 expresses areas with different capabilities with respect to positions the network node 230 may be arranged to match the route points, and even portions of the full route, with the areas with different capabilities (such as drone supporting 5G only at 28 GHz) and to determine a route matching in an optimal manner with the service requirements. As a non-limiting example of the generated data for generating the flight plan may be provided information such as “recommended flight altitude between 50 m and 75 m from Point Z to Point X to get maximum benefit from the millimeter wave 5G beamforming function available at that location” or “avoid Point Y between 08:00 and 09:30 due to morning rush hour crowds gathering there” or “take alternative route between Point A and B on May 1st due to 5G base station maintenance on the most optimal route”.

According to some other example embodiment the generation of data for generating the flight plan may comprise e.g. filtering relevant data received from the network management entity 250 e.g. on a basis of the data received from the control device 210, such as based on data relating to the flight route and/or data representing at least one service requirement. In response of the filtering the network node 230 may be arranged to deliver the filtered data to the control device 210 for determination of an actual flight route for the UAV 110.

In various embodiments the network node 230 may serve a plurality of mobile network operators in the described manner. In such embodiments the data received from the control device 210 may carry, in addition to the above mentioned data items, data indicating directly or indirectly a mobile network operator whose subscription the UAV 110 uses for communication. For example, the mobile network operator may be indicated with an identity of the mobile network operator or with an identifier representing International Mobile Subscriber Identity (IMSI) or with any similar data item. In response to a receipt of the data item the network node 230 may be arranged to obtain the data item and to determine the mobile network operator. If the received data item does not indicate it directly, a database may be arranged to store data indicating it. For example, an inquiry comprising the received data item, such as IMSI, as a parameter may be made to the database, which responds with an indication of the mobile network operator. Alternatively or in addition, the response may comprise a network address or any similar information on the network management entity 250 where the inquiry of the capability (cf. step 420) may be performed. In this manner, the network node 230 may serve a plurality of mobile network operators.

According to some further example embodiment the network node 230 may be arranged to inquire the capability information from a plurality of mobile communication networks e.g. managed by a plurality of mobile network operators i.e. from a number of network management entities and to compare the capabilities and to select one or more mobile network operators whose network capability matches with the requirements required to perform the task and with the received data representing one or more route points. The response to the control device 210 may comprise an indication on the mobile communication network whose capability corresponds optimally to the requirements. The control device may be arranged to obtain the indication on the mobile network operator and to instruct the UAV 110 to couple communicatively to the optimal mobile communication network. In this kind of example embodiment, the subscription used by a communication module of the UAV 110 is preferably such that it allows connecting to any, or at least to some, mobile communication networks within an area, e.g. one at a time.

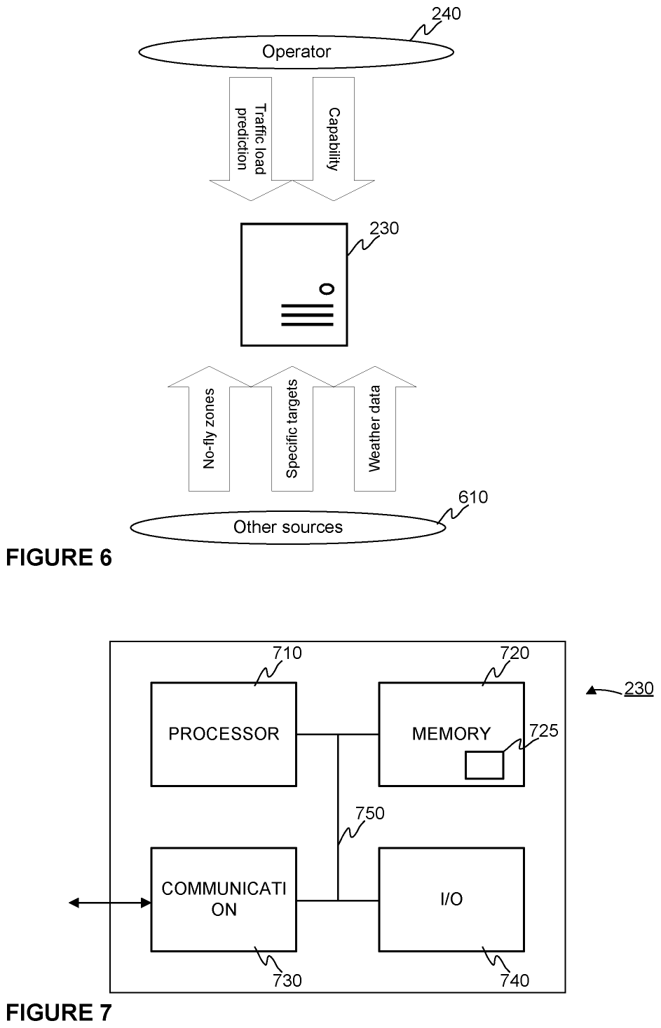

Some further aspects with respect to various example embodiments are schematically illustrated in FIG. 6. Namely, as discussed, the network node 230 may inquire a capability information of a mobile communication network from a specific network management entity. In addition to non-limiting examples in the foregoing description the mobile communication network may e.g. provide capability information e.g. with respect to a 3D space (xyz) having predefined dimensions, such as 100 m×100 m×100 m, along a planned flight route comprising e.g. data indicating:
assumed data throughput within the space xyz
latency within the space xyz
reliability of a connection within the space xyz
other QoS related characteristic within the space xyz
amount of crowd within the space xyz
network load within the space xyz (e.g. with respect to time)
assumed out-of-service situation within the space xyz (e.g. due to network repair/modification)
pricing related aspects of a communication service within the space xyz (e.g. price per QoS and/or an amount of data)

Additionally, the network node 230 may also be arranged to obtain further data and use that a generation of a flight plan in full or in part. The further data may be any other data which may be taken into account in the generation of the flight plan e.g. together with the data received from the network operator. The further data may be retrieved from any applicable sources. For example, in addition to the capability data from the mobile network operator the network node 230 may e.g. be arranged to inquire data which predicts traffic load, such as data traffic load, in various locations of the mobile communication network 240 in question. The mobile network operator may generate such a prediction by following roaming of the served subscription and to detect if a number of subscriptions within an area changes, i.e. increases or decreases, rapidly, i.e. more than pre-defined limit. Since the variation in load within the network coverage may cause degradation in service, the network node 230 may be arranged to take the traffic load prediction into account in its operation. Moreover, the network node 230 may be arranged to obtain further data from other sources 610. The other sources may refer to various network entities, such as server devices residing e.g. in a data network 140, which may be arranged to generate data applicable in the generation of the flight route. For example, the further data may be data expressing so-called no-fly zones in the area, data expressing special data of one or more targets in the area and/or weather data. The data expressing no-fly zones may define one or more areas in which flying e.g. with UAVs is not permitted. The special data may e.g. express tall buildings in the area. Weather data, in turn, may provide information on current weather conditions, but also forecasting it. In response to receiving the pieces of data the network node 230 may be arranged to consolidate the data and generate fusion data for the flight route.

An algorithm arranged to take as an input at least some of the above disclosed parameters may be arranged to generate the final flight route. The algorithm may be arranged to provide varied weights to different parameters if certain aspects is desired to be emphasized. In some example embodiments a user may provide at least some of the weights either directly or indirectly to the application.

As discussed above, the network node 230 may perform at least some steps of the method as described. FIG. 7 illustrates schematically as a block diagram a non-limiting example of the network node 230 applicable to perform the method. The block diagram of FIG. 7 depicts some components of an apparatus that may be employed to implement an operation of the network node 230. The apparatus comprises a processor 710 and a memory 720. The memory 720 may store data and computer program code 725. The apparatus may further comprise communication means 730 for wired and/or wireless communication with other apparatuses. Furthermore, I/O (input/output) components 740 may be arranged, together with the processor 710 and a portion of the computer program code 725, to provide a user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus may be communicatively coupled to each other via a bus 750 that enables transfer of data and control information be-tween the components.

The memory 720 and a portion of the computer program code 725 stored therein may be further arranged, with the processor 710, to cause the apparatus, i.e. the network node 230, to perform a method as described in the foregoing description. The processor 710 may be configured to read from and write to the memory 720. Although the processor 710 is depicted as a respective single component, it may be implemented as respective one or more separate processing components. Similarly, although the memory 720 is depicted as a respective single component, it may be implemented as respective one or more separate components, some or all of which may be integrated/removable and/or may provide permanent/semi-permanent/dynamic/cached storage.

The computer program code 725 may comprise computer-executable instructions that implement functions that correspond to steps of the method as will be described when loaded into the processor 710. As an example, the computer program code 725 may include a computer program consisting of one or more sequences of one or more instructions. The processor 710 is able to load and execute the computer program by reading the one or more sequences of one or more instructions included therein from the memory 720. The one or more sequences of one or more instructions may be configured to, when executed by the processor 710, cause the apparatus to perform the method be described. Hence, the apparatus may comprise at least one processor 710 and at least one memory 720 including the computer program code 725 for one or more programs, the at least one memory 720 and the computer program code 725 configured to, with the at least one processor 710, cause the apparatus to perform the method as described.

The computer program code 725 may be provided e.g. a computer program product comprising at least one computer-readable non-transitory medium having the computer program code 725 stored thereon, which computer program code 725, when executed by the processor 710 causes the apparatus to perform the method. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Still further, the computer program code 725 may comprise a proprietary application, such as computer program code for participating to a generation of the flight plan.

Any of the programmed functions mentioned may also be performed in firmware or hardware adapted to or programmed to perform the necessary tasks.

A non-limiting example of a control device 210 operated by the user of UAV 110 is schematically illustrated in FIG. 8 as a block diagram. The block diagram of FIG. 8 depicts some components of an apparatus that may be employed to implement an operation of the control device 210. The apparatus comprises a processor 810 and a memory 820. The memory 820 may store data and computer program code 825. The apparatus may further comprise communication means 830 for wired and/or wireless communication with other apparatuses. Furthermore, I/O (input/output) components 840 may be arranged, together with the processor 810 and a portion of the computer program code 825, to provide a user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus may be communicatively coupled to each other via a bus 850 that enables transfer of data and control information between the components.

The memory 820 and a portion of the computer program code 825 stored therein may be further arranged, with the processor 810, to cause the apparatus, i.e. the control device 210, to cooperate with the network node 230 and the UAV 110 in the manner as described. The processor 810 may be configured to read from and write to the memory 820. Although the processor 810 is depicted as a respective single component, it may be implemented as respective one or more separate processing components. Similarly, although the memory 820 is depicted as a respective single component, it may be implemented as respective one or more separate components, some or all of which may be integrated/removable and/or may provide permanent/semi-permanent/dynamic/cached storage.

The computer program code 825 may comprise computer-executable instructions that implement functions that correspond to steps of the method as will be described when loaded into the processor 810. As an example, the computer program code 825 may include a computer program consisting of one or more sequences of one or more instructions. The processor 810 is able to load and execute the computer program by reading the one or more sequences of one or more instructions included therein from the memory 820. The one or more sequences of one or more instructions may be configured to, when executed by the processor 810, cause the apparatus to perform the method be described. Hence, the apparatus may comprise at least one processor 810 and at least one memory 820 including the computer program code 825 for one or more programs, the at least one memory 820 and the computer program code 825 configured to, with the at least one processor 810, cause the apparatus to operate as described.

The computer program code 825 may be provided e.g. a computer program product comprising at least one computer-readable non-transitory medium having the computer program code 825 stored thereon, which computer program code 825, when executed by the processor 810 causes the apparatus to operate as described. The computer-readable non-transitory medium may com-prise a memory device or a record medium such as a CD-ROM, a DVD, a Blu-ray disc or another article of manufacture that tangibly embodies the computer program. As another example, the computer program may be provided as a signal configured to reliably transfer the computer program.

Still further, the computer program code 825 may comprise a proprietary application, such as computer program code for participating to a generation of the flight plan.

Some example embodiments relate to a system comprising at least the control device 210, the UAV 110, the network node 230 and the network management entity 250 as described.

The specific examples provided in the description given above should not be construed as limiting the applicability and/or the interpretation of the appended claims. Lists and groups of examples provided in the description given above are not exhaustive unless otherwise explicitly stated.

1. A method for generating data for a flight plan for an unmanned aerial vehicle, the unmanned aerial vehicle being controllable with a control device, the method comprises:
receiving, by a network node, data relating to a flight route of the unmanned aerial vehicle and data representing at least one service requirement for a mobile communication network required by the unmanned aerial vehicle during a flight,
inquiring, by the network node, from at least one a mobile communication network a capability to provide the at least one service requirement,
receiving, by the network node, from the at least one mobile communication network a response to the inquiry, and
generating, by the network node, data for the flight plan in accordance with data included in the response to the control device of the unmanned aerial vehicle.

2. The method of claim 1, wherein the response from the at least one mobile communication network comprises position data representing at least one area where the at least one mobile communication network is capable of fulfilling the at least one service requirement.

3. The method of claim 2, wherein the data for the flight plan is generated in accordance the position data representing the at least one area where the at least one mobile communication network is capable of fulfilling the at least one service requirement.

4. The method of claim 1, wherein the at least one service requirement is at least one of: a bandwidth of a communication channel applicable by the unmanned aerial vehicle; a latency in a communication channel applicable by the unmanned aerial vehicle.

5. The method of claim 1, wherein a generation of data for the flight plan corresponds to one of: a generation of at least one flight route; a generation of at least one route point for generating the flight route.

6. The method of claim 1, the method further comprising:
inquiring, by the network node, further data for generating data for the flight plan.

7. The method of claim 6, wherein the further data is inquired from at least one of: the mobile communication network; a data network.

8. The method of claim 7, wherein the further data inquired from the mobile communication network represents a prediction of a traffic load in the mobile communication network.

9. The method of claim 7, wherein the further data inquired from the data network represents at least one of: data expressing no-fly zone in an area, data expressing special data of one or more targets in the area; weather data.

10. A network node for generating data for a flight plan for an unmanned aerial vehicle, the network node comprising:
at least one processor; and
at least one memory including computer program code;
the at least one memory and the computer program code configured to, with the at least one processor, cause the network node to:
receive data relating to a flight route of the unmanned aerial vehicle and data representing at least one service requirement for a mobile communication network required by the unmanned aerial vehicle during a flight,
inquire from at least one a mobile communication network a capability to provide the at least one service requirement,
receive from the at least one mobile communication network a response to the inquiry, and
generate data for the flight plan in accordance with data included in the response to the control device of the unmanned aerial vehicle.

11. The network node of claim 10, wherein the network node is arranged to receive the response from the at least one mobile communication network, the response comprising position data representing at least one area where the at least one mobile communication network is capable of fulfilling the at least one service requirement.

12. The network node of claim 11, wherein the network node is arranged to generate data for the flight plan in accordance with the position data representing the at least one area where the at least one mobile communication network is capable of fulfilling the at least one service requirement.

13. The network node of claim 10, wherein the at least one service requirement is at least one of: a bandwidth of a communication channel applicable by the unmanned aerial vehicle; a latency in a communication channel applicable by the unmanned aerial vehicle.

14. The network node of claim 10, wherein the network node is arranged to generate data for the flight plan by one of: generating at least one flight route; generating at least one route point for generating the flight route.

15. The network node of claim 10, wherein the network node is further arranged to:
inquire further data for generating data for the flight plan.

16. The network node of claim 10, wherein the network node is arranged to inquire the further data from at least one of: the mobile communication network; a data network.

17. The network node of claim 16, wherein the network node is arranged to interpret the further data inquired from the mobile communication network to represent a prediction of a traffic load in the mobile communication network.

18. The network node of claim 16, wherein the network node is arranged to interpret the further data inquired from the data network to represent at least one of: data expressing no-fly zone in an area, data expressing special data of one or more targets in the area; weather data.

19. A non-transitory computer-readable medium on which is stored a computer program for generating data for a flight plan for an unmanned aerial vehicle, which computer program, when executed by at least one processor, cause a network node to perform the method comprising:
receiving, by a network node, data relating to a flight route of the unmanned aerial vehicle and data representing at least one service requirement for a mobile communication network required by the unmanned aerial vehicle during a flight,
inquiring, by the network node, from at least one a mobile communication network a capability to provide the at least one service requirement,
receiving, by the network node, from the at least one mobile communication network a response to the inquiry, and
generating, by the network node, data for the flight plan in accordance with data included in the response to the control device of the unmanned aerial vehicle.

20. A system for generating data for a flight plan for an unmanned aerial vehicle, the system comprising:
a control device, and
a network node, comprising:
at least one processor; and
at least one memory including computer program code;
the at least one memory and the computer program code configured to, with the at least one processor, cause the network node to perform:
receive data relating to a flight route of the unmanned aerial vehicle and data representing at least one service requirement for a mobile communication network required by the unmanned aerial vehicle during a flight,
inquire from at least one a mobile communication network a capability to provide the at least one service requirement,
receive from the at least one mobile communication network a response to the inquiry, and
generate data for the flight plan in accordance with data included in the response to the control device of the unmanned aerial vehicle,
wherein the network node is arranged to
receive data relating to a flight route of the unmanned aerial vehicle from the control device, and
include data in a response to the control device for generating the flight plan in accordance with data included in the response to the control device of the unmanned aerial vehicle.
